(19) United States
(12) Patent Application Publication
(10) Pub. No.: US 2008/0013565 A1
(43) Pub. Date: Jan. 17, 2008

(54) Reverse Polling Algorithm For Shared Resources To Reduce Collisions In A Network

(75) Inventors: Gary W. Batchelor, Tucson, AZ (US); Brian J. Cagno, Tucson, AZ (US); Yolanda Colpo, Tucson, AZ (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/457,830

(22) Filed: Jul. 17, 2006

(51) Int. Cl. H04L 12/413; H04L 12/403

(52) U.S. Cl. 370/445; 370/449

(57) ABSTRACT

A method for reducing collisions within a plurality of networks, each of the plurality of networks having a plurality of workstations physically communicating over a plurality of shared communication channels, the method comprising: determining if a communication channel is available for transmitting data between the plurality of workstations; transmitting the data between all or part of the plurality of workstations via the communication channel; controlling the transmitted data between the plurality of workstations via a controller; monitoring the transmitted data by using a logic circuit; generating reverse polling of shared resources to reduce the collisions from occurring upon transmitting the data over the communication channel when a determination is made that at least two workstations of the plurality of workstations attempt to access a same shared resource within the plurality of networks; and notifying the controller of the reverse polling of the transmitted data and performing a low frequency time synchronization.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to collisions on a communications network, and particularly to a method of a first processor polling a first resource in a first direction and a second processor polling a second resource in a second (opposite) direction for reducing the collisions and also creating a large synchronization window which can be used to eliminate collisions.

2. Description of Background

Collisions on a communications network are problematic. Consider, for example, Ethernet, which is a local area network (LAN) technology that allows transmission of information between computers at speeds of 10 million bits per second (Mbps), 100 Mbps (Fast Ethernet) and, more recently, one gigabit per second. Ethernet assumes that an unlimited number of devices can be connected on a shared transmission medium such as a thick coaxial in the original 10 Mbps Ethernet, as well as thin coaxial, twisted-pair, and fiber optic media in the newer versions. To control the exchange of data between systems connected on the shared medium, Ethernet uses a protocol called CSMA/CD (Carrier Sense Multiple Access/Collision Detect).

A shared transmission medium may include several redundant systems. In these redundant systems it is often necessary that two processors poll a set of shared resource for status. If the processors are running the same code and power up together, they will be attempting to access a shared resource at the same time. This can cause constant collisions on the communication link requiring extra code to handle and extra time to wait for the first processor to release the shared resource. These collisions create processor overhead. In an Ethernet network, a collision is the result of two devices on the same Ethernet network attempting to transmit data at exactly the same time. The network detects the “collision” of the two transmitted packets and discards them both. Collisions are a natural occurrence on Ethernet networks. However, it is common for Ethernet networks to use CSMA/CD as a method of allowing devices on a network to “take turns” using a signal carrier line. As a result, when a device wants to transmit, it checks a signal level of the carrier line to determine whether someone else is already using it. If it is already in use, the device waits and retries, perhaps in a few seconds. If it isn't in use, the device transmits.

Each device then waits a random amount of time and retries until it is successful in getting the transmission sent. CSMA/CD are rules defining how network devices respond when two devices attempt to use a data channel simultaneously and encounter a data collision. The CSMA/CD rules define how long the device should wait if a collision occurs one or more times. However, this results in a very time consuming process that drains network efficiency by having multiple nodes make multiple attempts to receive or to forward information.

In particular, in redundant systems it is often necessary that two processors be required to poll a set of shared resource for status. If the processors are running the same code and power up at the same time, the processors may be attempting to access a shared resource at the same time. This causes collisions on the communication network, which requires extra code to handle, and extra time to wait for the first processor to release the shared resource.

Thus, it is well known that network collisions occur due to two devices on a network attempting to transmit data at the same time. Therefore, it is desired to reduce or virtually eliminate unnecessary network collisions in order to increase network efficiency and optimize information flow.

### SUMMARY OF THE INVENTION

The shortcomings of the prior art are overcome and additional advantages are provided through the provision of a method for reducing and virtually eliminating collisions within a plurality of networks, each of the plurality of networks having a plurality of workstations physically communicating over a plurality of shared communication channels, the method comprising: determining if a communication channel is available for transmitting data between the plurality of workstations; transmitting the data between all or part of the plurality of workstations via the communication channel; controlling the transmitted data between the plurality of workstations via a controller; monitoring the transmitted data by using a logic circuit; generating reverse polling of shared resources to reduce collisions; transmitting a low frequency time synchronization to eliminate the collisions from occurring upon transmitting the data over the communication.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that reduces or virtually eliminates network collisions by allowing a first device to poll in one direction and allowing a second device to poll in the opposite direction minimizing collisions due to the fact access to the same shared resource is only attempted once per polling loop which improves upon today's method where the same resources are always polled at the same time. A large window of time is also created, one polling loop, which is guaranteed to be collision free allowing for polling synchronization to occur and can be used to eliminate the need for the devices to access a resource at the same time altogether.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a flowchart showing a method for reducing collisions within a plurality of networks.

### DETAILED DESCRIPTION OF THE INVENTION

One aspect of the exemplary embodiments is a method for reducing the need of network devices in sharing resources. Another aspect of the exemplary embodiments is a method for polling such devices in opposite directions when there is a need for sharing resources.

Collisions in networks occur when two or more devices attempt to send a signal along the same channel at the same time. Thus, a collision is an interference that results when two devices on a network start transmitting at the same time. Increased collisions are often the result of too many users on the network, which results in a lot of contention for networked bandwidth. From a user's point of view, performance of the network becomes slow. All networks require some sort of mechanism to either prevent collisions altogether or to recover from collisions when they occur.

Furthermore, a collision occurs when two or more devices on the network attempt to transmit over a single data channel (e.g., a twisted pair copper wire cable or an optical fiber cable) simultaneously, and, after a brief, random, and different interval of time (called a backoff delay) has elapsed for each device, the devices attempt to transmit again. If another collision occurs, the time intervals from which the random waiting times are selected are increased step-by-step in a process referred to as exponential back off.

Collisions are not uncommon in a shared medium that has many computers in the same network segment. When a packet collision occurs, the packets are either discarded or sent back to their originating stations and then retransmitted in a timed sequence to avoid further collision. Packet collisions can result in a loss of packet integrity or can impede performance of the network.

One solution is to use Carrier Sense Multiple Access/Collision Detect (CSMA/CD), which is the most widely used protocol (i.e., set of rules) for determining how the network devices respond in the event of one or more collisions. CSMA/CD is a modification of pure CSMA. Carrier Sense (CS) refers to the fact that a transmitting device listens for a carrier wave (i.e., a waveform that carries signals) before attempting to transmit. That is, it first tries to detect a presence of an encoded signal from another device. If a carrier is sensed, the device then waits for the transmission in progress to finish before starting its own transmission. Multiple Access (MA) describes the fact that multiple devices send and receive on a medium. Thus, all other nodes that use the medium generally receive transmissions by one node.

Furthermore, collision detection is used to improve CSMA performance by terminating transmission as soon as a collision is detected, and reducing the probability of a second collision on the next try. The techniques used for detecting collisions depend on the type of media: in the case of electrical wires, for example, collisions are detected by comparing the transmitted data with the received data.

In contrast, CSMA/CD operates at the physical layer, which is the bottom level in the OSI (Open Systems Interconnection) seven-layer model that is used to standardize and simplify definitions with regard to computer networks. This layer defines all physical and electrical specifications for devices used to interface to the network, and it deals with data only in terms of raw bits (i.e., it does not recognize MAC addresses, IP addresses, and packets).

A major feature of CSMA/CD is that it is simple to implement. This has helped make it an international standard and an important part of the Ethernet that is the most widely deployed architecture for LANs (Local Area Networks). Therefore, CSMA/CD is a type of contention protocol. Networks using the CSMA/CD procedure are simple to implement but do not have deterministic transmission characteristics. The CSMA/CD method is internationally standardized in IEEE 802.3 and ISO 8802.3.

In a CSMA/CD protocol, a packet collision rate is the amount of packet collisions that occur in the network in a specified time period, usually one minute. The router typically monitors the packet collision rate. The network collisions monitoring source monitors the number of network collisions that have been detected on all TCP/IP (Transmission Control Protocol/Internet Protocol) interfaces on a subscriber since the host was booted. The number of collisions is an indicator of network traffic. If the number of collisions is consistently high, then the network is most likely overloaded. To reduce the number of collisions, it is recommended to reorganize the network.

In a CSMA/CD protocol, because collisions are only detected by the systems (or devices) that are trying to transmit, the total number of collisions on the network could be measured using special monitoring hardware or data from a central switch. As a result, each system (or device) on the network can recognize and/or determine different throughput and collision rates for the same network.

In fact, collisions are counted by Ethernet interface hardware. The hardware is quite intelligent because it is given a pointer to a list of packets to transmit and counts how many collisions occur while the packets are being sent. Different interfaces use different counting methods. The older interfaces based on the AMD LANCE design use a two-bit counter, which means that there are none, one, two, or “lots” of collisions. However, at high collision rates the counter may sometimes under-report the real number of collisions occurring on the network.

One solution to under-reporting the real number of collisions is to use a protocol analyzer to detect the number of collisions. Therefore, if a user is encountering network performance problems, the user can easily test the network with a protocol analyzer, or a similar device, to measure collisions, runt packets, or CRC (Cyclic Redundancy Check) errors. However, under regular operating conditions, some collisions are normal. But a high percentage of collisions, runt packets, or CRC errors indicates a serious performance problem that could very well be related to the differing interframe gap settings of the various network cards on your network. Nevertheless, this solution has not been able to sufficiently remedy network collision problems within networks.

However, a better solution, as recommended by the exemplary embodiments of the present application, would be to poll resources in opposite directions when a potential network collision is detected. To poll means that there is a polling interval. The question is, what is the state of the network during these intervals? The larger the network, the more polling required. Active polling systems are fine for monitoring a handful of systems, but to manage a network, other mechanisms are necessary, as recommended by the exemplary embodiments of the present application.

For example, if two processors in a redundant system poll their shared resources in reverse order, then the network collision would be minimized, if not eliminated entirely because a large window of time is created to allow for background time synchronization. By having one processor polling in one direction and the other processor polling from the opposite direction, commutation collisions are virtually eliminated. In fact, most systems allow for a slot identifier. In such cases, this information is used to determine the order at which each processor should poll their shared resources.

For instance, Processor A and Processor B share resources 1, 2, 3 and 4. When the Processors A and B boot, they discover which slot in the system they are plugged into. The slot information is used to notify Processor A to poll the resources in the following order; 1, 2, 3, and then 4. Conversely, the slot information is used to notify Processor B to poll in the opposite order; 4, 3, 2, and then 1. As an example, it is assumed that two processors are running at 10 MHz polling ten shared resources every 250 mS. Assuming a typical clock drift of 10 ppm, it takes 1.3 days until there is even a possibility of a collision. That 1.3-day window can be used to pass a once a day timestamp. The processors can then realign their polling on the once a day timestamp and prevent collisions on the bus. Consequently, polling resources in reverse or opposite directions virtually eliminates unnecessary network collisions, increase network efficiency, and optimizes information flow throughout the network.

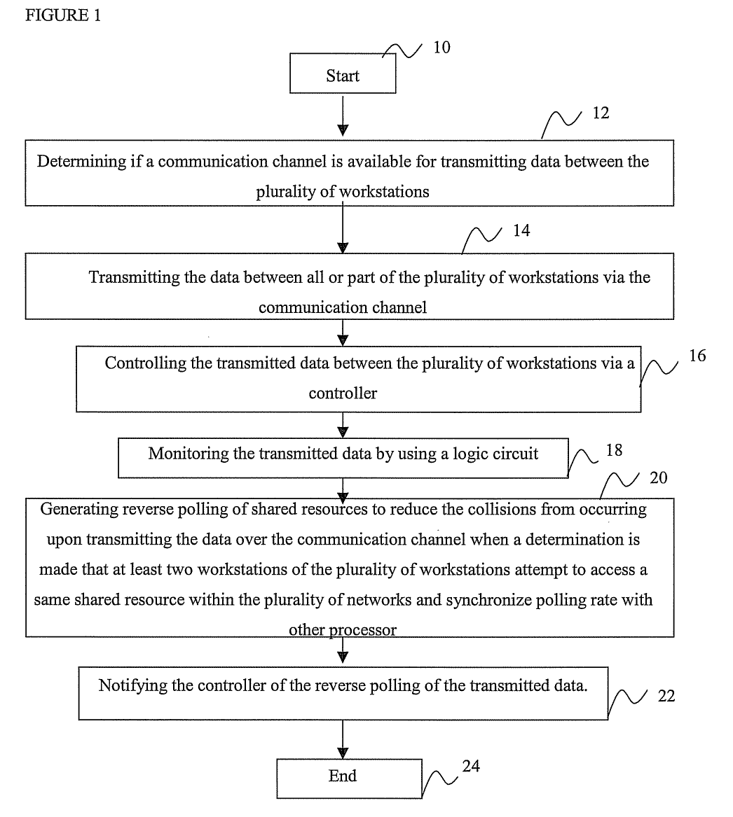

Specifically, FIG. 1 illustrates one example of a flowchart showing a method for reducing collisions within a plurality of networks. The method includes a plurality of workstations physically communicating over a plurality of shared communication channels. At step 10, the method commences when one of the plurality of workstations sends a request to receive data from another one of the plurality of workstations. At step 12, it is determined if a communication channel is available for transmitting data between the plurality of workstations. At step 14 the data is transmitted between all or part of the plurality of workstations via the communication channel. At step 16 the transmitted data between the plurality of workstations is controlled via a controller. At step 18 the transmitted data is monitored by using a logic circuit. At step 20 reverse polling of shared resources to reduce the collisions from occurring upon transmitting the data over the communication channel is generated when a determination is made that at least two workstations of the plurality of workstations attempt to access a same-shared resource within the plurality of networks and perform a background time synchronization. At step 22 the controller is notified of the reverse polling of the transmitted data. At step 24, the process ends.

Thus, network management entities can poll devices to check the values of certain variables or to transmit data. Polling can be automatic or user-initiated, but agents in the managed devices respond to all polls. Agents are software modules that first compile information about the managed devices in which they reside, then store this information in a management database, and finally provide it to management entities within network management systems via a network management protocol, such as the CSMA/CD.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for reducing collisions within a plurality of networks, each of the plurality of networks having a plurality of workstations physically communicating over a plurality of shared communication channels, the method comprising:
determining if a communication channel is available for transmitting data between the plurality of workstations;
transmitting the data between all or part of the plurality of workstations via the communication channel;
controlling the transmitted data between the plurality of workstations via a controller;
monitoring the transmitted data by using a logic circuit;
generating reverse polling of shared resources to reduce the collisions from occurring upon transmitting the data over the communication channel when a determination is made that at least two workstations of the plurality of workstations attempt to access a same shared resource within the plurality of networks; and
notifying the controller of the reverse polling of the transmitted data.

2. The method of claim 1, wherein the communication is performed on a wireless medium.

3. The method of claim 1, wherein the transmitted data on the communication channel is transmitted in packets in accordance with a CSMA/CD protocol.

4. The method of claim 1, wherein the monitoring step includes detecting reception of an incomplete incoming packet.

5. The method of claim 1, wherein each of the plurality of workstations includes a slot identifier for determining an order at which at least two workstations poll the same shared resource.

6. The method of claim 5, wherein the slot identifier polls one of the at least two workstations in one direction and another of the at least two workstations in an opposite direction.
